(19) United States
(12) Patent Application Publication
(10) Pub. No.: US 2014/0362223 A1
(43) Pub. Date: Dec. 11, 2014

(54) Theft Deterrent System at Product Display Area with Targeted Advertising

(71) Applicant: Setronics Corp., Billerica, MA (US)

(72) Inventors: Brian LaCroix, Burlington, MA (US); Don Kwapien, Fitchburg, MA (US); Dean Auger, Littleton, MA (US)

(21) Appl. No.: 14/297,085

(22) Filed: Jun. 5, 2014

Related U.S. Application Data
(60) Provisional application No. 61/831,427, filed on Jun. 5, 2013.

(51) Int. Cl. H04N 7/18; G08B 13/196; G07G 3/00

(52) U.S. Cl. CPC H04N 7/183; G07G 3/003; G08B 13/19602
USPC 348/150; 348/152; 348/155

(57) ABSTRACT

A theft deterrent system and method at a product display area. In a preferred embodiment, the system displays video of customers on a public view monitor (PVM) located near the product display area in response to detecting customer interactions with the products in the product display area. The system also provides target advertising via audio messages and video messages displayed on the PVM in response to detecting the interactions. The system enhances customer shopping experience by providing welcoming messages as the customers approach the product display area while also deterring would-be thieves, and provides upsell capability by sending audio and video advertising messages for related products to the PVM in response to product retrieval attempts such as “reach-ins” or selection of the products.

### RELATED APPLICATIONS

This application claims the benefit under 35 USC 119(e) of U.S. Provisional Application No. 61/831,427, filed on Jun. 5, 2013, which is incorporated herein by reference in its entirety.

### BACKGROUND OF THE INVENTION

Owners of retail establishments are under a constant struggle to provide consumers with a range of products at competitive prices and a pleasant shopping experience while also controlling cost. A major factor that increases the cost of products is loss of product due to theft, also known as “shrinkage” especially for high-value items. While thefts include “smash and grab” incidents involving single individuals, a growing number of thefts are associated with groups of individuals working together, referred to as organized retail crime (ORC). Increasingly, retail establishments are deploying theft deterrent systems at product display areas to combat product loss and the growing threat of ORC.

Current theft deterrent systems use a variety of components to monitor retail establishments for suspicious activity and to detect loss. These systems include components such as video cameras and recorders and public view monitors (PVM) mounted at exit and entry points of the retail establishments. The public view monitors display the video from the video cameras to provide awareness to the consumers that they are under surveillance as part of loss prevention strategy.

Additional components or strategies currently in use include “product lockdown,” where high-value items are placed behind the retail counter or require intervention by retail personnel to access the items, and active inventory management systems. The active inventory systems typically rely on tagging products. These systems send alert messages in response to detecting activity for products including the tags.

### SUMMARY OF THE INVENTION

A fundamental tradeoff in the design and implementation of theft deterrent designs is to strike a balance between deterring and mitigating shoplifting and organized retail crime while also not discouraging legitimate sales.

The current solutions for deterring theft at product display areas have a number of problems. Because so many retail establishments utilize public view monitors mounted at exit and entry points, consumers have become increasingly de-sensitized to active surveillance. This reduces the effectiveness of surveillance as a theft deterrent. Product lockdown strategies not only inhibit sales of the items under lockdown, but also discourage consumers from buying other products. Tagging systems typically generate alerts only after the product is in the consumer's shopping cart or only when the consumer attempts to exit the retail establishment. It is also expensive and cumbersome to deactivate in many applications. Active inventory management systems which employ RFID and similar technology for unique identification of the product unit are also expensive and add complexity to the sales process.

Embodiments of the present invention take a different approach to deterring theft. A public view monitor (PVM) is included near a product display area, and customers see themselves in video captured from video cameras that often include the product display area in the field of view of the video cameras. The video is displayed on the PVM as the customers interact with the product display area. The invention also provides audio and/or visual messaging to heighten the customers perception that both the location is being actively monitored and that presence or activity at the product has been noted. This same messaging also simultaneously enhances the legitimate customers shopping experience and furthers marketing efforts to such consumers. Concurrently, the system discretely notifies store personnel at the earliest time possible of the customer interactions.

Specifically, the embodiments include a customer messaging system and a management and control system that provide audio and/or video messages to customers near the product display area in response to detecting the customer interactions with the product display area. The system further notifies store personnel once the customer presence is sensed at the product area. The system can also infer the customer presence or activity as a potential theft. Not only does this approach deter theft, but by incorporating surveillance video management equipment already present as well as the conventionally passive PVM's video display capability it can also do so in a more cost effective manner than current systems and methods.

Moreover, embodiments of the theft deterrent system provide the ability to present audio and/or video messages at the product display area that welcome or thank customers in response to detecting the customer interactions. In addition, the theft deterrent system presents targeted audio or visual advertising messages associated with the products at the product display area in response to detecting the customer interactions. In some examples, the video displayed on the PVM includes the video advertising messages. The messages may provide “upsell” capability for retailers by, for instance, welcoming consumers to purchase other products and services that are related to the products the consumers are currently interacting with. These activities not only do not detract from the retail experience of legitimate customers, but also enhance the retail experience for customers while also promoting sales of products for the retailers.

In general, according to one aspect, the invention features a theft deterrence and analysis system, which comprises a video camera that generates video of a product display area, a public view monitor (PVM) positioned relative to the product display area, and a management and control system.

The management and control system controls, in response to detecting customer interactions with the product display area, messaging at the product display area including audio messages and/or video displayed on the PVM, the video displayed on the PVM including video from the video camera.

The customer interaction with the product display area can include approach of the product display area by the customers, attempts at product retrieval, e.g, in the product display area, and/or motion associated with the products at the product display area. A typical example of a product retrieval attempt is a “reach-in.”

In a preferred embodiment, the system further comprises a product retrieval sensing camera that generates video of the product display area and detects the customer interactions with the product display area, through video analytics, for example. The management and control system changes the video displayed on the PVM in response to detecting the customer interactions. The video often includes audio and/or video welcoming messages and audio and/or video advertising messages.

The management and control system also includes a customer messaging system and a logical control system. The logical control system changes the video displayed on the PVM in response to detecting the customer interactions by selecting messages from the customer messaging system, mixing the messages and the video from the video camera into mixed video data, and providing the mixed video data for display on the PVM.

If the messages are strictly audio, then the PVM typically retains the display of the product area view provided by the PVM enclosed camera or an alternate exterior camera. If video messaging is included, the control logic provided by the logical control system changes the video displayed on the PVM in response to detecting the customer interactions by selecting messages from the customer messaging system. The audio and or video messages can include audio and/or video welcoming messages, such as those that convey expressions of thanks, and audio and/or video advertising messages.

The management and control system notifies an audio amplification system to present an audio message to the customers in response to detecting the customer interactions. The management and control system preferably detects product retrieval customer interactions by enabling definition of an area of interest within the video from the product retrieval sensing camera defined by a vertical plane in front of the product display area or a boundary around the product display area, and identifying traversal of the area of the interest by the customers in the video.

The theft deterrence and analysis system also includes sensor devices that define a motion trigger zone near the product display area, and the management and control system detects product retrieval customer interactions from sensor data sent by the sensor devices that indicates traversal of the motion trigger zone by the customers.

The management and control system notifies loss prevention personnel in response to detecting the customer interactions, and does so by generating trigger signals to notification components in response to detecting the customer interactions in some implementations. The notification components send indications and messages associated with the detected customer interactions to the loss prevention personnel in response to receiving the trigger signals.

The store personnel notification components in the preferred embodiment include visual and audible indicators in store locations such as loss prevention as well as customer service areas, logic to manipulate the MCS system in order to “pop up” or present video of the product area with or without complementary warning alerts, also electronic messaging or email capability which might include images or video from the product area. This notification allows loss prevention to respond to further assist a legitimate customer or more typically to counteract a theft.

It is another aspect of the invention to feature a theft deterrence and analysis system that comprises a video camera, a public view monitor (PVM), and a video management system. The video camera generates video of a product display area. The public view monitor is positioned relative to the product display area. The video management system controls video displayed on the PVM in response to detecting customer interactions with the product display area, and forwards images of customers in the video to loss prevention personnel in response to detecting the customer interactions.

It is yet another aspect of the invention to feature a targeted advertising system. The targeted advertising system comprises a video camera that generates video of a product display area, a public view monitor (PVM) positioned relative to the product display area, a video management system, and an enterprise message content server. The management and control system includes audio and/or video messages associated with products at the product display area and controls video displayed on the PVM in response to detecting customer interactions with the product display area, the video displayed on the PVM including the audio and/or video messages. The enterprise message content server periodically updates the audio and/or video messages on the management and control system over a network cloud.

In examples, the targeted advertising system includes logical control which defines customer presence and/or interaction at the product display area, a public view monitor (PVM) positioned relative to the product display area with associated audio amplification equipment.

It is yet another aspect of the invention to feature a theft deterrence and analysis system. The theft deterrence and analysis comprises a video camera that generates video of a product display area that includes products, a public view monitor (PVM) positioned relative to the product display area, point of sale (POS) terminals that generate POS transaction data for transactions associated with the products at the POS terminals, a system data archive that stores the POS transaction data, and a management control system.

The management and control system controls video displayed on the PVM in response to detecting customer interactions with the product display area, records the video from the video camera, creates and saves events in response to detecting the customer interactions, and compares the events in conjunction with the POS transaction data and the recorded video to identify and/or validate theft of the products.

In general, according to yet another aspect, the invention features generation of potential product theft events as well as analysis in conjunction with conventional point of sale (POS) transaction data to identify events which have corroboration from the POS data of as likely theft events. This identification can then be used to determine periods of time where surveillance video may capture the theft or related information.

In general, according to yet another aspect, the invention features a method for deterring theft at a product display area. The method comprises generating video of the product display area via a video camera, positioning a public view monitor (PVM) relative to the product display area, and controlling messaging at the product display area including audio messages and/or video displayed on the PVM in response to detecting customer interactions with the product display area, the video displayed on the PVM including video from the video camera.

Preferably, detecting the customer interaction with the product display area includes detecting approach of the product display area, most essentially detecting attempts to retrieve products in the product display area; and/or generally detecting motion associated with the products at the product display area. Preferably, the method detects attempts at product retrieval by enabling definition of an area of interest within the sensing camera's video defined by a vertical plane in front of the product display area, or a boundary around the product display area, and identifying motion within the area of the interest by the customers in the video.

The method can further interpret motion within the area of interest as traversal by the customer according to a threshold percentage of pixel illumination value changes as well as the speed of such changes and be complemented by combinatorial logic incorporating other sensor inputs such as ultrasonic/PIR sensors, weight change sensors under the product being protected, photoelectric sensors around the product under protection, and conditional outputs from other systems that may be present such as active management systems. The defined event is logged as such, the display area video is so tagged, and store personnel are notified of the event. A different combinatorial logic may be used to define customer presence accordingly but for purely sales support and market analysis purposes.

It is yet another aspect of the invention that marketing statistics may be generated from the events defined as customer presence and product retrieval attempts which indicate the extent of customer interest in the product primarily as defined by the duration and number of each event type and also subjective information which may be gathered from associated recorded video in the product display area.

A further aspect of the invention includes generating marketing data related to customer interaction with the product display area and storing the marketing data, recording the video from the video camera, creating and storing events in response to detecting the customer interactions, wherein the events define consumer reaction to the product display area, and developing consumer behavior marketing metadata and statistics in relation to the product display area using the stored events.

Customer presence and interaction at the product area is detected by use of but not restricted to ultrasonic and or PIR sensor in the product area, detection of presence and activity related to the product by motion change within defined areas of interest, photoelectric sensors, break of door enclosure sensors, pressure sensitive mats, even mechanical outputs from existing product management systems.

Less obvious to the customer are detection sensors of customer activity at the product area which typically include another camera connected to the surveillance management and control system (MCS), MCS incorporated motion sensing logic, recording and other management functions, also MCS discrete relay and other electronic outputs. Implementations of the invention add logical control of product area messaging based on the motion and sensing outputs as well as store personnel notification. The audio-visual messaging system responds to the logical control with messaging which may be purely audio in nature or include video displayed on the PVM in response to detecting customer interactions with the product display area.

It is yet another aspect of the invention to have the store management and control system respond to the detected potential theft by both recording as tagged this event for later investigation as well as transmitting video to store personnel for immediate use in evaluating and responding to the potential theft or alternately a need for customer assistance. An auxiliary function of the system is to permit live audio “voice-down” to the product area.

The invention may also feature an enterprise message content system capable of scheduling message content at product display areas protected by the invention across the site or even a number of such sites such as a retail store chain.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a system block diagram of a theft deterrent system according to principles of the present invention;

FIG. 2 is a schematic diagram of an exemplary signal processing system that receives a video trigger signal in response detecting customer interactions, and generates new trigger signals for triggering notification components;

FIG. 3 is a schematic diagram of an exemplary system data archive that stores Point of Sale (POS) transaction data from a POS terminal;

FIG. 4 is a front view of an exemplary public view monitor (PVM) including an integrated security camera and speaker;

FIG. 5 is an image showing a preferred embodiment of the theft deterrent system for a product display area in a retail establishment that includes a PVM preferably mounted on a ceiling above the product display, where the positioning of the PVM permits display of video data of consumers on the PVM as they interact with the products at the product display area;

FIG. 6 shows a front view of a cabinet product display area including motion sensors and contact switches for detecting motion consumer interactions associated with products in the product display area;

FIG. 7 is a schematic diagram showing a multi-layered scene of video data, including an area of interest defined as a plane in front of a product display area within the scene;

FIG. 8 is a schematic diagram showing an area of interest associated with sensor devices such as motion sensors for detecting reach-in events at a product display area, the area of interest defined as a motion trigger zone between the sensor devices;

FIG. 9A shows a front view of a PVM, where the PVM is displaying both video and video advertising messages on its display screen in response to the consumer performing a “reach-in” customer interaction for products at the product display area;

FIG. 9B shows a front view of a PVM, where the PVM is displaying both video and video welcoming messages on its display screen in response to a customer “approach” interaction that indicates customer presence at the product display area;

FIG. 10 is a flow chart that provides an exemplary method for detecting a “reach-in” product retrieval attempt consumer interaction at a product display area, and alerting the consumer and loss prevention personnel in response to the detected reach-in event;

FIG. 11 is a flow chart that provides detail for the method of FIG. 10, showing how the new trigger signals are processed;

FIG. 12 is a flow chart that provides a method for identifying and validating potential thefts associated with reach-in customer interactions;

FIG. 13 is a block diagram showing major components of the theft deterrent system that are associated with an audio override message or “voice down” feature; and

FIG. 14 is a flow chart showing a method for sending audio override messages associated with components of the block diagram in FIG. 13; and

FIG. 15 is a state machine diagram that identifies major states of the theft deterrent system that occur during its operation.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms of the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

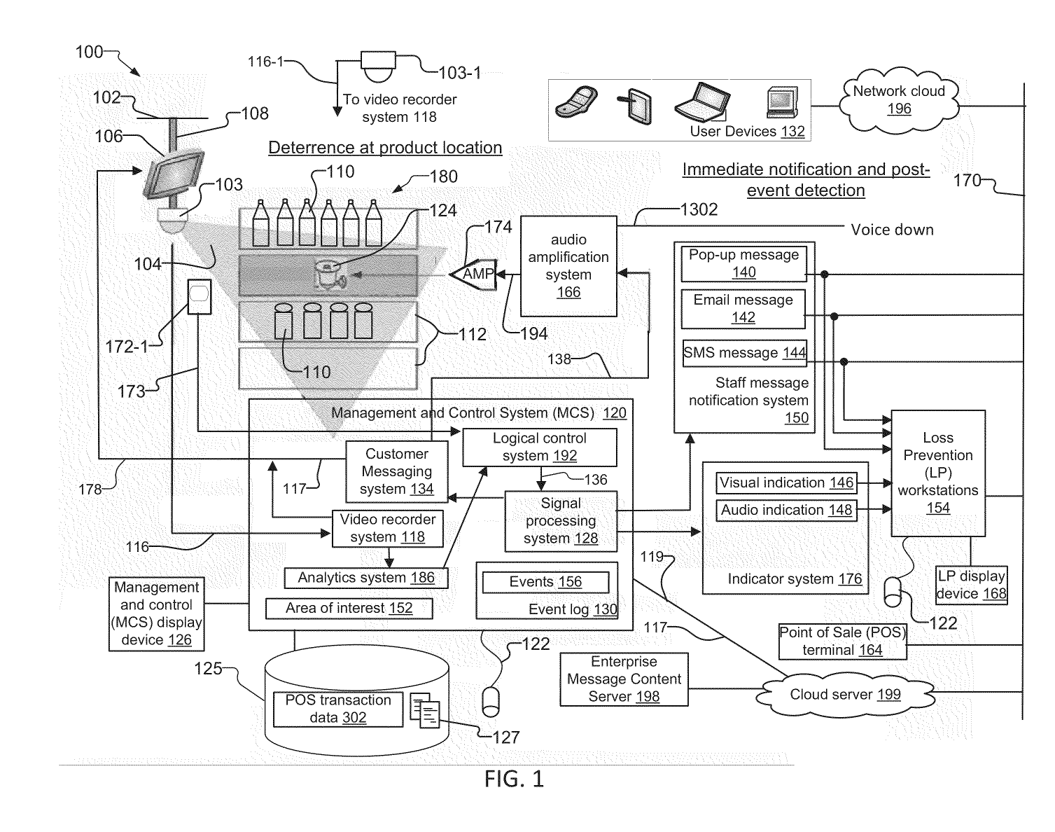

FIG. 1 is a system block diagram of an exemplary theft deterrent system 100 according to principles of the present invention. The major components of the system 100 include a public view monitor (PVM) 106 positioned relative to a product display area 180, an audio amplification system 166, a management and control system (MCS) 120, one or more video cameras 103 that capture video of the product display area 180, a product retrieval sensing camera 103-1 that also captures video of the product display area 180 but is utilized for detecting customer interactions with products 110, an enterprise message content server 198, point of sale (POS) terminals 164, notification systems that notify loss prevention personnel via user devices 132 and a loss prevention (LP) workstation 154. The notification systems include a staff message notification system 150 and an indicator system 176.

The video data 116 captured by the video camera 103, also known as a scene display camera, is displayed on the PVM 106. In contrast, the video data 116-1 captured by the product retrieval sensing camera 103-1 is typically not displayed on the PVM 106. This video data 116-1 is received and recorded by the video recorder system 118 and analyzed by the analytics system 186 to detect customer interactions with the products 110. In response to detecting customer interactions in the video 116-1, the analytics system 186 works in conjunction with the logical control system 192 to select audio and/or video messages 117 from the customer messaging system 134 in response to detecting the customer interaction in the video data 116-1. The MCS 120 then presents the selected messages 117 to the consumer 802 on the PVM 106. The messages 117 can include both audio and video messages, and the PVM 106, in one embodiment, has an integrated speaker 124 for presentation of the audio messages. In other examples, the MCS 120 presents video messages for display on the PVM 106, and audio messages 194 to an external speaker 124, preferably located behind the product display area 180.

Typically, the product retrieval sensing camera 103-1 is mounted overhead of the product display area 180. The video camera 103 has a field of view 104 that includes the product display area 180. Preferably, the PVM 106 is mounted to a ceiling 102 above the product display area 180 via a mast 108. The mast 108 typically extends from the ceiling 102 to a point just above the product display area 180. This allows the PVM 106 to be as near as possible to the product display area 180 so customers 802 can see themselves in the video displayed on the PVM 106 as they interact with the products 110 at the product display area 180.

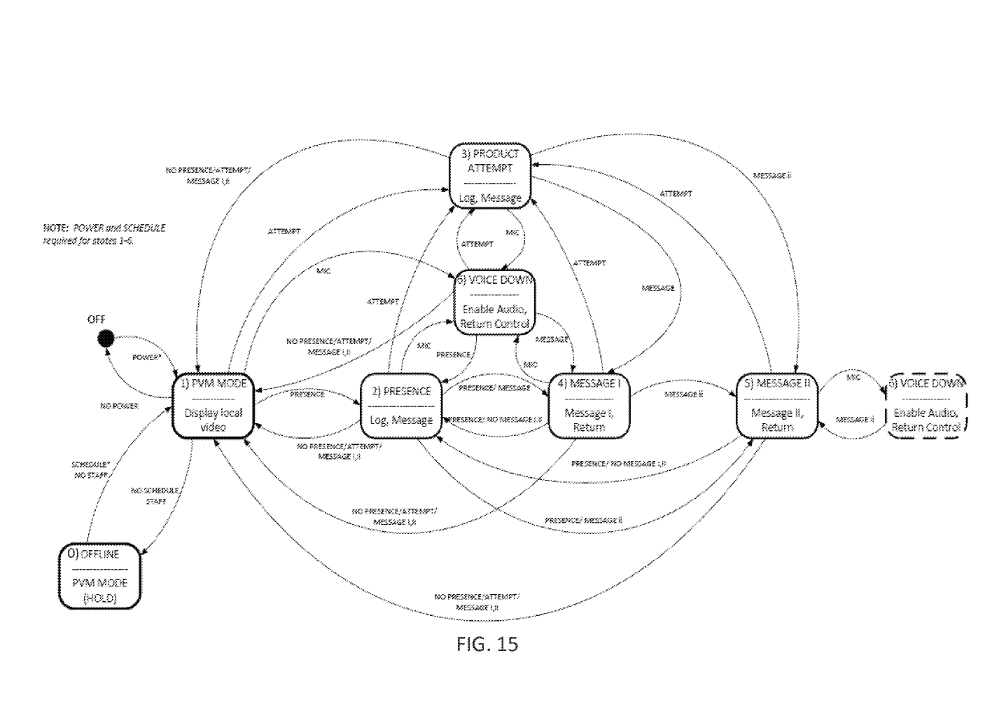

The management and control system 120 detects customer interactions involving the customers 802 with the product display area 180 via video 116-1 from the product retrieval sensing camera 103-1 and sends messages to the customer 802 either with audio via the audio amplification system 166 and/or with video 116 displayed on the PVM 106 in response to detecting the customer interactions with the product display area 180. In the non-messaging state referred to as “PVM mode” in the state diagram of FIG. 15 included herein below, the video 116 displayed on the PVM 106 includes video transmitted directly from the video camera 103 and video 116 transmitted through the video recorder system 118. The management and control system 120 includes a customer messaging system 134, a video recorder system 118, a logical control system 192, an analytics system 186, a signal processing system 128, and an event log 130. The video recorder system 118 accepts the video 116 from one or more video cameras 103, video 116-1 from product retrieval sensing cameras 103-1, and records the video 116 and 116-1 according to surveillance objectives and for subsequent analysis by the analytics system 186. The customer messaging system 134 is associated with the transmission of audio messages 194 and/or video messages 117 to customers 802 at the product display area 180.

Preferably, system configuration includes defining one or more areas of interest 152 associated with the recorded video 116-1 from the product retrieval sensing camera 103-1 in order to determine customer interactions with the product display area 180. The software on the management and control system 120 typically resides on the video recorder system 116. This software allows a system configurator or operator to view and define the area of interest 152 within a scene of video 116-1 he observes using a MCS display device 126. In order to avoid false positive indications of product retrieval the area of interest 152 may be defined as a planar surface on the order of an inch in actual thickness just in front of the products 110.

The analytics system 186 can be used to detect customer retrieval of the products. Preferably, the analytics system 186 determines the customer interactions, such as reach-ins, by inferring movement of the customers 802 and the products 110 relative to the area of interest 152 in the video 116-1 from the product retrieval sensing camera 103-1. A typical implementation is to define a threshold percentage illumination change of a minimum number of pixel elements within the area of interest 152 as constituting indication of a product retrieval attempt. Additionally, this analytics function can reside on the product retrieval sensing cameras 103-1 that support this capability. In either embodiment, operators define the area of interest 152 typically using pointing devices such as a mouse 122 or by using hand gestures on a touchscreen implementation of the MCS display device 126, in examples. In another example, the analytics system 186 can also be used to detect customer presence in the area by defining another area of interest 152-1 from the product scene display camera/video camera 103 and inferring presence of the customer in the product display area 180.

In addition to detecting the customer interactions by analyzing video 116-1, the MCS 120 can detect the customer interactions using sensor devices 172 located near the product display area 180. Sensor devices 172 such as a motion sensor 172-1 define a motion trigger zone as an area of interest 152 near the product display area 180. The management and control system 120 detects product retrieval customer interactions from sensor data 173 sent by the sensor devices 172 that indicates traversal of the motion trigger zone/area of interest 152 by the customers 802 in response to the product retrieval interactions.

The MCS 120 generates alarm output as a message trigger signal 136 in response to determining the customer product retrieval or customer presence. Experience has shown that this does not adversely affect the retail experience of the law-abiding consumer 802, who is accustomed to surveillance, while also deterring would-be thieves that prefer to work undetected. The signal processing system 128 accepts the message trigger signal 136, and processes the video trigger signal 136 into new trigger signals 138 for notifying the notification components in response to determining the customer interactions. The MCS 120 displays video 116 of the customer 802 on the PVM 106 in response to detecting customer interactions with the product display area 180. Alternately the logical control system 192 can be configured to only notify store personnel as to the occurrence of customer presence or retrieval events.

The theft deterrent system 100 additionally provides targeted advertising messages to the customer 802 in response to determining the customer interactions. The MCS 120 provides audio messages 194 and/or video advertising messages 117 that not only enhance the customer buying experience but also promote sales of related products 110. The messaging system 134 includes video messages 117 associated with the products 110 in the product display area 180. In examples, the video messages 117 include video welcoming messages 117-1 and video advertising messages 117-2. The messaging system 134 is preferably implemented as a media server.

The messaging system 134 preferably supports both audio and visual messaging. The messaging system 134 preferably includes media files stored as multiple tracks. The server can respond to multiple triggers (at least two) and provide at least two messages. The media content can be stored on flash drive for local updates to the media messages or the content may be updated over a network connection locally or even remotely. Typical media formats include MPG/.MP2/.MP4/.M2V/.TP/.AVI/.MOV/.WMV/.JPG/.BMP/.GIF. In most applications, the messages should be brief in duration, on the order of 4 to 12 seconds. The response time in relation to the product retrieval event start should be less than 1 second and preferably less than 0.5 seconds and is often less than 200 milliseconds in order for the customer/thief to clearly associate the message with his interaction with the product 110.

The messaging system 134 provides messages 117 associated with the products 110 at the product display area 180 in response to the logical control system 192 determining the customer product retrieval. The MCS 120 can display the video 116 and the video advertising messages 117 independently on the PVM 106.

In an alternative embodiment, the MCS 120 combines the video 116 from the video camera 103 and the video messages 117 sent in response to the product retrieval sensing cameras 103-1 detecting the customer interaction into mixed video data 178 for simultaneous display on the PVM 106.

The audio amplification system 166 may be used to support the audio portion of a video message 117 or to provide an audio-only message 194. It may also be used to provide a “voice down” live conversation 1302 with the customer 802 by store personnel. In an alternate embodiment, the audio amplification system 166 and its amplification 174 are included as part of the customer audio visual messaging system 134. In other examples, the sound amplification 174 is included within the PVM 106.

The video messages 117 preferably include video welcoming messages 117-1 and video advertising messages 117-2. Typically, the MCS 120 controls the display of the video welcoming messages 117-1 on the PVM 106 in response to the MCS 120 detecting approach customer interactions, and controls the display of the video advertising messages 117-2 on the PVM 106 in response to the MCS 120 detecting reach-in customer interactions. In this way, the customer 802 receives video welcoming messages 117-1 in response to approaching the product display area 180 and receives video advertising messages 117-2 in response to customer presence at or retrieval of products 110 at the product display area 180.

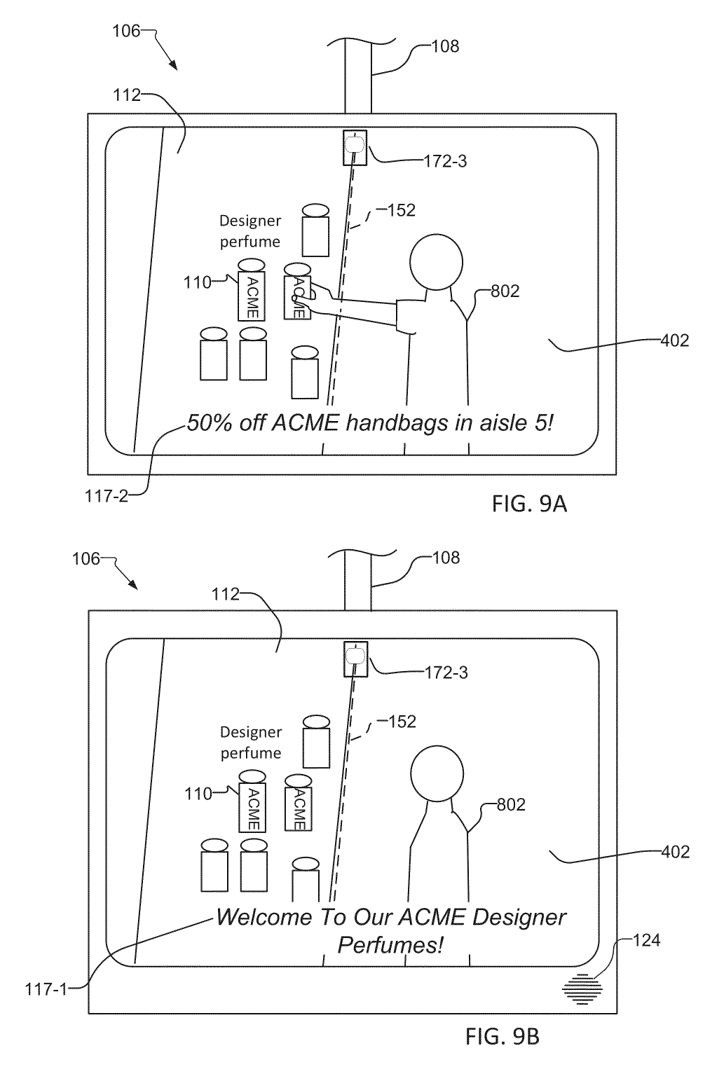

For example, in response to the consumer 802 reaching in for a bottle of designer perfume on one of the shelves 112 of the product display area 180, the consumer 802 not only sees herself in the video 116 on the PVM 106 reaching for the bottle, but is also visually alerted to a sale on apparel made by the same designer at another product display area 180 of the retail location via a video advertising message 117-2. The video advertising message 117-2 is displayed on the PVM 106, in one example. More detail for the display of video advertising messages 117-2 and video welcoming messages 117-1 accompanies the description of FIG. 9A and FIG. 9B, respectively, included herein below.

Additionally, an enterprise message content server 198 provides periodic updates of the messages 117 to the messaging system 134 of the MCS 120 via a cloud server 199. In one example, the customer messaging system 134 pulls new messages 117 from the enterprise message content server 198 according to a schedule.

In another example, the MCS 120 forwards images 119 of customers 802 in the video 116 to loss prevention personnel in response to detecting the customer interactions. The analytics system 186 captures the image 119 from frames of recorded video 116 of the video recorder system 118. The MCS 120 then sends the image 119 via the cloud server 199 over the security network 107 to loss-prevention workstations 154 and to user devices 132 via an intermediary network cloud 196.

The MCS 120 also sends audio messages 194 to the consumer 802 in response to determining the customer interactions. An audio notification system 166 receives an audio trigger signal of the new trigger signals 138 sent by the signal processing system 128. The audio trigger signal is associated with the products 110 at the product display area 180. The audio amplification system 166 selects an audio message 194 indicated by the message trigger signal. Amplifier 174 amplifies the audio message 194, and the audio message 194 is presented to the customer 802 via speaker 124. The speaker 124 is preferably located behind the product display area 180, but can also be integrated with the PVM 106, in examples. As with the video messages 117, the audio messages 194 typically include welcoming messages independent of the products 110 and messages associated with the products 100 or related products 100.

Another capability of the theft deterrent system 100 is the ability to notify loss prevention personnel in response to the MCS 120 detecting the customer interactions. For this purpose, the new trigger signals 138 sent by the signal processing system 128 include unique trigger signals for notifying different notification components. Notification components such as the staff message notification system 150 and the indicator system 176 send indications and messages associated with the detected customer interactions to the loss prevention personnel in response to receiving the new trigger signals 138.

The staff message notification system 150 sends messages to loss prevention workstations 154 and user devices 132 over a network cloud 196 in response to receiving the new trigger signals 138. The messages include pop-up messages 140, email messages 142, and SMS messages 144, in examples. The indicator system 176 sends visual indications 146 and audio indications 148 to loss prevention workstations 154. Alternately, the notification system can send visual indications 146 and audio indications 148 to audio and visual indicator electronics dedicated to this notification function as triggered by the notification system. The loss prevention workstations 154 are typically located within a loss prevention office on site at the retail location, but can also exist remotely or as mobile computing devices. The LP workstations 164 communicate over the security network 170.

Operators interact with the loss prevention workstations 154 via an LP display device 168 using a touchscreen or mouse 122. In examples, the loss prevention workstations 154 can include integrated alarm panels that alert loss prevention personnel by turning on lights or sounding sirens of the alarm panels in response to receiving the visual indications 146 and audio indications 148, in examples.

The MCS 120 creates time-stamped events 156 in response to consumer interactions such as presence or product retrieval detected by the MCS 120 and stores the events 156 to the event log 130. In examples, events 156 are created in response to detecting the customer interactions, for saving information associated with internal activities of the MCS 120, such as stopping and starting of its components, and in response to receiving video 116, updates to advertising messages 117, and sensor data 173, in examples. The customer interaction with the product display area 180 includes approach of or presence at the product display area 180, product retrieval for products 110 in the product display area 180, and/or motion associated with the products 110 at the product display area 180.

Point of Sale (POS) terminals 164 send POS transaction data 302 over the security network 170 in response to POS transactions for the products 110. A system data archive 125 stores the POS transaction data 302. The theft deterrent system 100 can identify and validate potential thefts by correlating time-stamped video 116 from the video recorder system 118 with time-stamped events 156 associated with customer product retrieval, in conjunction with time-stamped POS transaction data 302, in one example. The system data archive 125 also stores reports 127 generated by the MCS 120.

The MCS 120 can accept and process video 116 and sensor data 173 from multiple product display areas 180 throughout a retail location, but a system configurator (typically will not leave this to the store) has to administratively configure this on the MCS 120 for each monitored product display area 180. In other examples, the logical control 192 within the MCS 120 can be integrated with PIC controllers that in turn control regions of retail locations, where each region includes multiple product display areas 180.

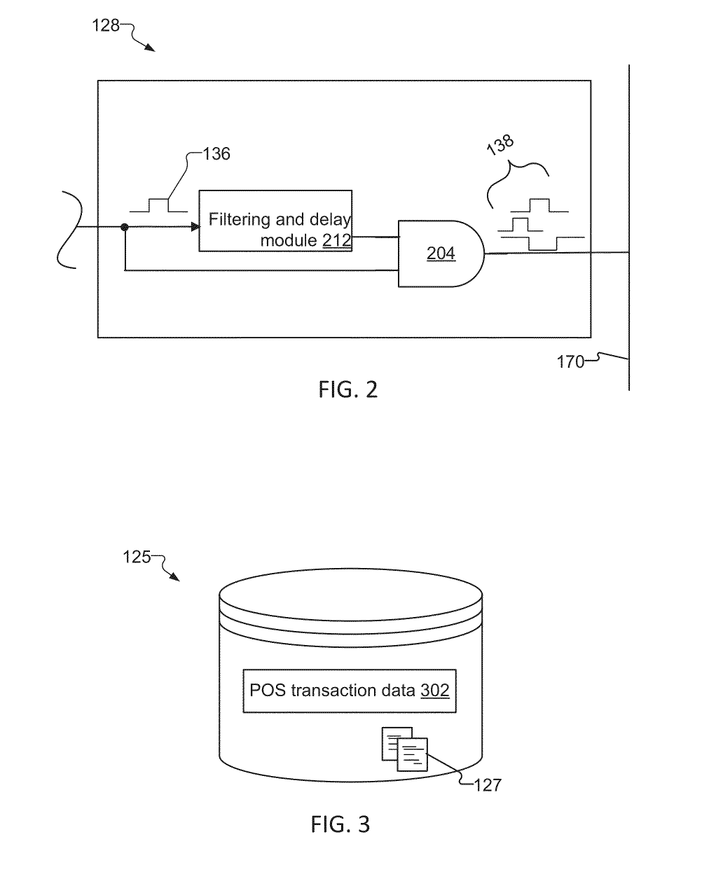

FIG. 2 is a schematic diagram of an exemplary signal processing system 128 that receives a message trigger signal 136 in response to detecting events associated with customer interactions at the product display area 180, and generates new trigger signals 138 for triggering notification components. The signal processing system 128 accepts the trigger signal 136, which is typically of the form of contact closure or TTL (Transistor-Transistor Logic) state changes.

This timing logic is also useful when incorporating existing systems for subsystem function such as the video recorder system 118 of FIG. 1 which subsystems may have operational timing characteristics which need to be adjusted to the overall system timing requirements.

In one embodiment, the signal processing system 128 includes a filtering and delay module 212 and discrete components such as an AND gate 204, discrete relays, timers. The filtering and delay module 212 provides a lag time between successive message trigger signals 136 associated with detected customer interactions.

In response to detecting the customer interactions, such as a product retrieval event, the logical control system 192 generates a message trigger signal 136. In turn, the signal processing system 128 creates new trigger signals 138 for the message trigger signal 136. The new trigger signals 138 notify separate notification components, which in turn alert loss prevention personnel and customers 802.

FIG. 3 shows a system data archive 125 that stores Point of Sale (POS) transaction data 302 from one or more POS terminals 164. The POS transaction data includes information associated with each product 100 sold at the POS terminals 164. This information includes the unique Stock Keeping Unit (SKU) number for each product 110, the number or location of the POS terminal 164, and an employee number or identifier of the individual that performed the transaction, in examples.

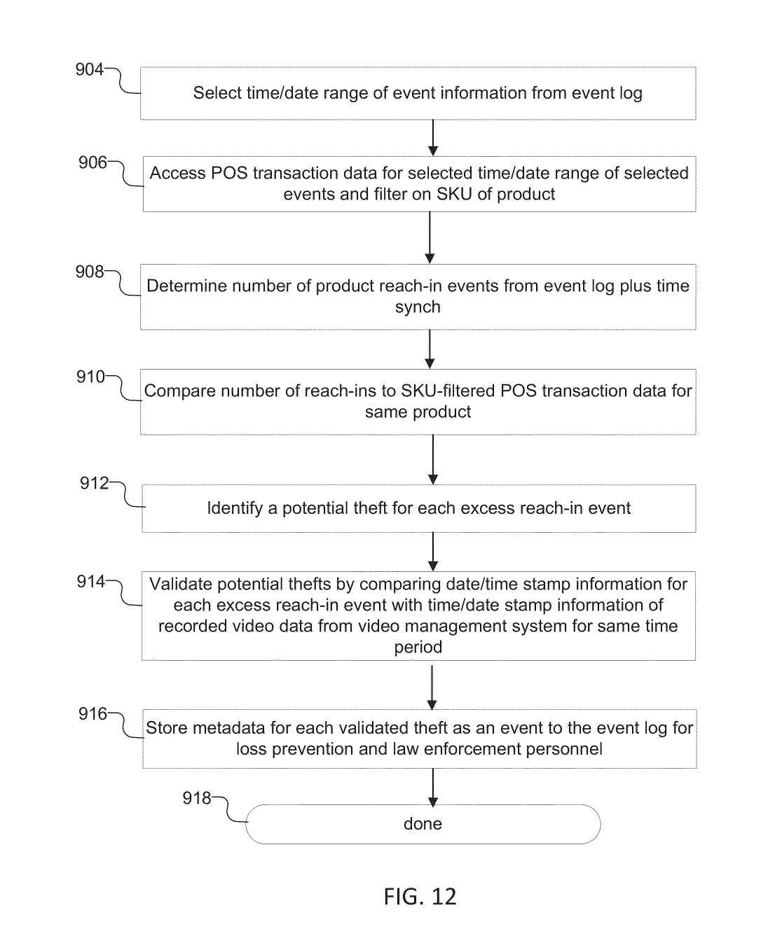

The theft deterrent system 100 correlates POS transaction data 302 in conjunction with time-stamped events 156 and video from the video recorder system 118 and/or analytics system 186 for post-event detection processing. An example of post-event detection processing is the ability for the theft deterrent system 100 to identify and validate potential thefts. More information associated with the usage of POS transaction data 302 is included within the description that accompanies FIG. 12, included herein below.

Reports 127 are generated by the MCS 120 and stored on the system data archive 125. Reports 127 include references to events 156 collected over time periods. Reports 127 provide useful statistics for loss personnel staff and marketing personnel, in examples. Marketing statistics within the reports 127 can include the following information calculated from events 156 based on system inputs and programmed logic:
Number of customer approaches by time interval
Durations of customer presence in product area
Statistical data on time before reach-in, reaction statistics to messaging
Statistics on audio overrides
Statistics of additional data input by store representative

In one example, the MCS 120 creates a report 156 that includes the number of times the door of a cabinet 602 in a product display area has been opened during peak hours.

In addition, a number of commercially prevalent analyses such as floor area heat mapping, customer queue and congestion statistics can be implemented based on system data.

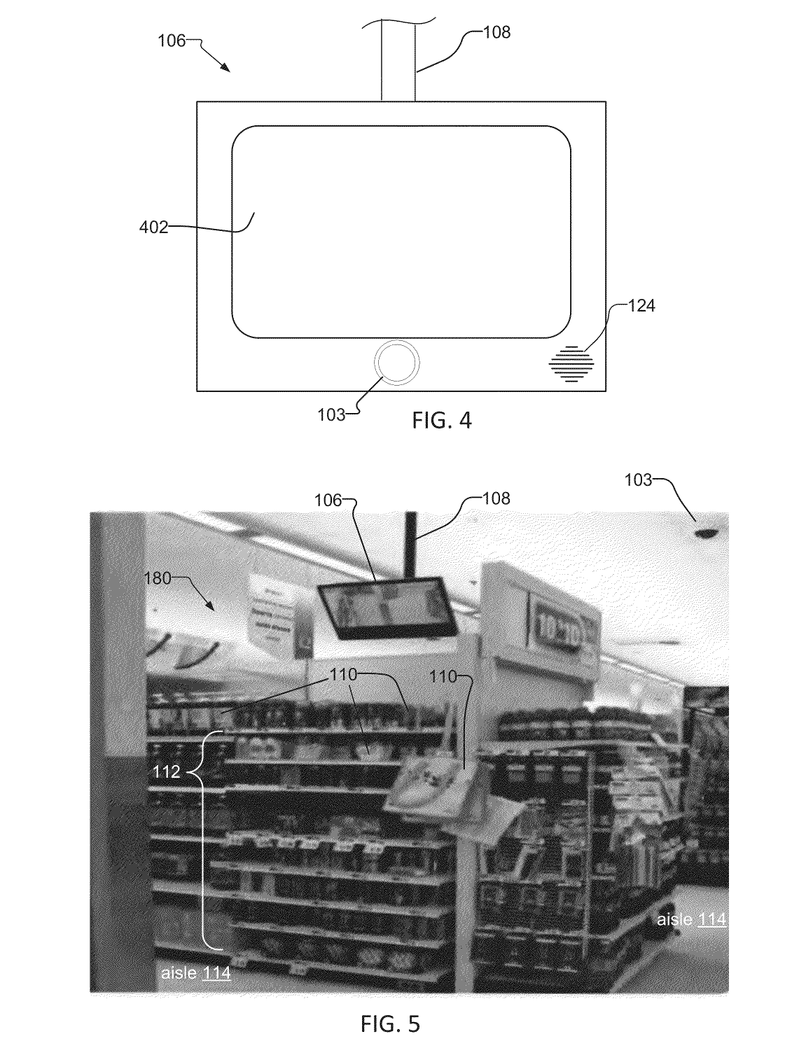

FIG. 4 is an embodiment of the PVM 106 that displays video data 116 of consumers 802 as they interact with products 110 at a product display area 180. The PVM 106 also displays video messages 117. The PVM 106 mounts to mast 108, and includes a display area 402 for displaying the video 116 from the video cameras 103, the video messages 117, and the mixed video data 178. The exemplary PVM 106 also includes an integrated video camera 103 and speaker 124. The speaker 124 plays audio messages 194 in response to the detected customer interactions.

Ideally the camera 103 and its recording will be selected to permit live and recorded resolution greater than 100 pixel per feet at the customer 802 and activity targets but no less than 50 pixel per feet. Recording of customer interaction events by the video recorder system 118 preferably includes pre-event footage. The event recording frame rate is typically 5 frame per second but preferably should be 10 frames per second or greater. Video recording should be maintained for the longest period anticipated prior to event investigation and archive of the events 156 in the event log 130 and should include an engineering safety factor of typically 20%.

FIG. 5 is an image of a product display area 180 in a retail establishment using the preferred location of the PVM 106 with respect to the product display area 180. The video camera 103 has a clear view of the products 110 on the shelves 112 of the product display area 180. A PVM 106 is preferably mounted on a ceiling 102 above the product display area 180, where the positioning of the PVM 106 permits display of video 116 of consumers 802 on the PVM 106 as the consumers 802 interact with the products 100 at the product display area 180.

The video camera 103 is positioned relative to the product display area 180 and aisles 114 to capture scenes of video data 116 that include consumers 802 interacting with the products 110 at the product display area 180. The PVM 106 is positioned relative to the product display area 180 to enable the consumers 802 to conspicuously view themselves in real-time within the scene displayed on the display area 402 of the PVM 106. This self-awareness of surveillance by the consumers 802 as they shop typically has no adverse effect on their shopping experience while also providing a deterrent to would-be thieves.

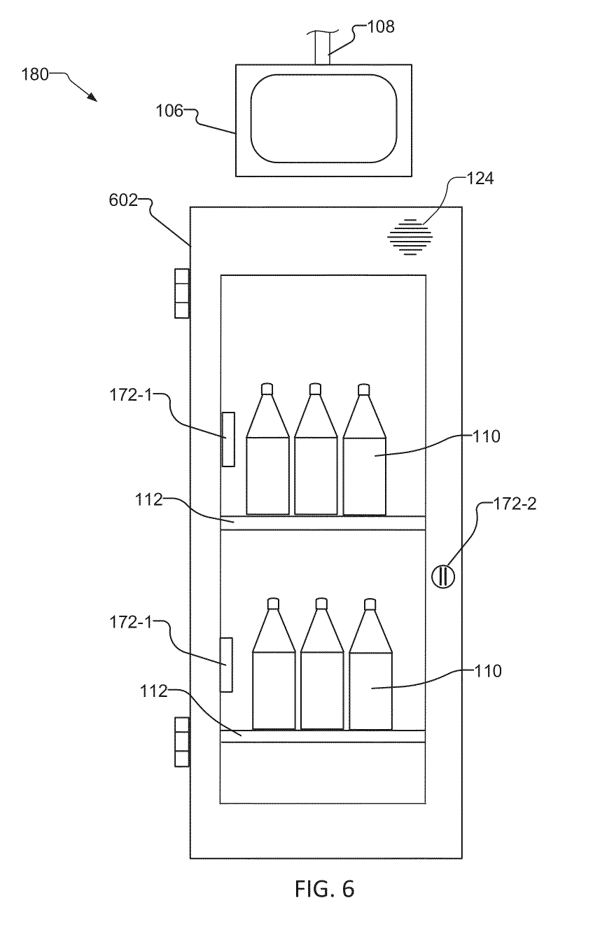

FIG. 6 shows a front view of a cabinet 602 embodiment of a product display area 180. The cabinet 602 has shelves 112, an integrated speaker 124, sensor devices 172 such as motion sensors 172-1 that detect motion of the customers, and contact switches 172-2 for detecting door openings of the cabinet 602. The PVM 106 is preferably mounted directly above the cabinet 602.

The cabinet 602 is a refrigerated display case that includes high-value beverages 110 such as energy drinks. In examples, the cabinet 602 can additionally include a variety of sensor devices 172 such as sensors that detect temperature variations, RFID-based detectors for inventory management and control, and sensors for detecting tampering and shock. The MCS 120 receives and analyzes the sensor data 173 from the sensor devices 172 to detect customer interaction with the cabinet 602, and creates associated time-stamped events 156 from the detected interactions.

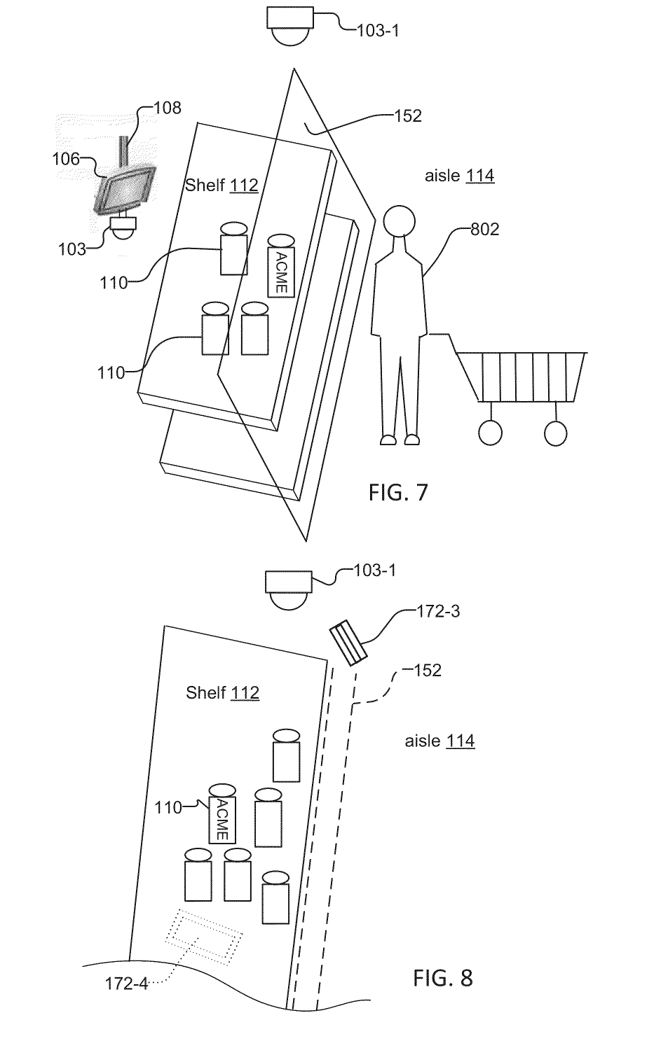

FIG. 7 is a schematic diagram showing a multi-layered scene of video data 116 including an area of interest 152. The area of interest 152 is preferably defined as a plane in front of a product display area 180 within the scene on the product retrieval sensing camera 103-1. An operator typically defines the area of interest 152 using the MCS display device 126 using interactive software of the MCS 120. A traverse of the area of interest 152 by a consumer 802 in the scene of the video 116-1 from the product retrieval sensing camera 103-1 is inferred by the analytics system 186 as a product retrieval attempt, such as a reach-in consumer interaction. The PVM 106 displays video 116 from the video camera 103 in response to the MCS 120 detecting the reach-in.

Consumer presence or “approach” at the product display area 180 is typically sensed via the product retrieval sensing camera 103-1 which is typically mounted overhead and looks down on the product display area 180. The video 116-1 from the product retrieval sensing camera 103-1 is provided to a video recorder system 118 with access to an analytics system 186 for performing motion analysis. The area of interest 152 is defined to coincide with human presence at the product display 180 area but as much as possible excludes general human traffic in the aisles 114.

FIG. 8 is a schematic diagram showing a motion trigger zone/area of interest 152 defined by sensor devices 172 such as an ultrasonic sensor or dual ultrasonic/infrared sensor 172-3. Traversal of the area of interest 152 by consumers 802 is detected by the sensor 172-3, and the analytics system 186 of the MCS 120 determines reach-in customer interactions from the sensor data 173 sent by the sensor 172-3. Other sensor devices 172 such as accelerometers can detect vibrations associated with consumer mishandling of and tampering with potentially fragile high-value products 110. Additionally, a pressure mat sensor 172-4, typically mounted under a shelf 112, can be utilized to detect a change in the weight of a product 110. Changes to the weight of a product 110 sensed by the pressure mat sensor 172-4 include a product retrieval attempt, or placement of an apparel item by a consumer 802 on top of a product 110, in examples.

FIG. 9A shows a front view of a PVM 106, where the PVM 106 is displaying a scene of video 116 from the video camera 103. In the video 116, the customer is performing a “reach-in” for fictional designer “ACME” perfume products 110 on shelves 112 at a product display area 180. The video 116 is displayed in the display area 402 of the PVM 106. The MCS 120 controls display of the video 116 in response to detecting the “reach-in” consumer interaction at the product display area 180.

The reach-in is detected by sensor devices 172, such as a dual ultrasonic/infrared sensor 172-3 which sends sensor data 173 to the MCS 120 when the consumer traverses the area of interest 152 defined by sensor 172-3. The MCS 120 determines the reach-in from analyzing the sensor data 173.

In response to the MCS 120 determining the reach-in for “ACME” perfume 110, the customer messaging system 134 includes a video advertising message 117-2 with the video 116 and sends the mixed video data 178 for display in the display area 402 of the PVM 106. In the example, the video advertising message 117-2 is associated with related goods and services offered by the same manufacturer, “ACME,” for ladies' handbags, in one example.

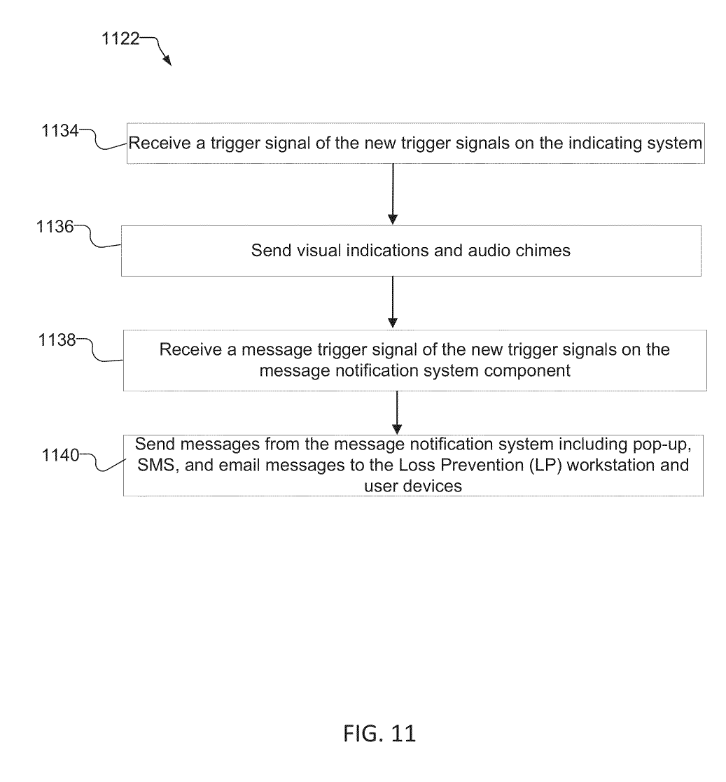

The MCS 120 can also notify the audio notification system 166 to send an audio message 194 to a speaker 124 located behind the product display area 180 in response to detecting the reach-in consumer interaction. More detail for the interaction between the MCS 120 and the audio amplification system 166 for triggering the sending of the audio messages 194 in response to the detected customer interactions is included in the description that accompanies FIG. 1, included herein above, and in the description that accompanies the flow chart of FIG. 11, included herein below.

FIG. 9B shows a front view of a PVM 106 that is substantially similar to the PVM 106 of FIG. 9A. FIG. 9B displays video 116 of a customer 802 that has approached the product display area 180 but has yet to “reach-in” for the products 110, as depicted in FIG. 7. In FIG. 9B, the PVM 106 additionally includes an integrated speaker 124.

In the video 116, the customer has approached the product display area 180 but has yet to reach-in for fictional designer “ACME” perfume products 110 on shelves 112 at the product display area 180. The video 116 is displayed in the display area 402 of the PVM 106. The MCS 120 controls display of the video 116 in response to detecting the approach customer interaction at the product display area 180. The approach interaction associated with the presence of the customer 802 in the aisle 114 near the product display area 180 is detected by sensor devices 172 such as a dual ultrasonic/infrared sensor 172-3 in one example. The MCS 120 detects the approach or “customer presence” from analyzing the sensor data 173 sent by the sensor devices 172.

Additionally, as in FIG. 9A, the MCS 120 can notify the audio notification system 166 to send an audio message 194 in response to detecting the customer interaction, which in FIG. 9B is an approach customer interaction. The audio notification system 166 presents the audio message 194 to the integrated speaker 124 of the PVM 106 to greet the customer 802.

In response to the MCS 120 determining the customer approach for “ACME” perfume 110, the video messaging system 134 includes a video welcoming message 117-1 with the video 116, and sends the mixed video data 178 for display in the display area 402 of the PVM 106. In the example, the video welcoming message 117-1 welcomes the consumer to shop for the specific products 110 in the products display area 180, the “ACME” designer perfume. In other examples, the video welcoming message 117-1 can be a product-independent message that thanks the customer for their patronage, a warning message to a would-be thief, or a public service announcement in the event of emergency or natural disaster.

In other examples, the audio message 194 and/or video message 117 can offer assistance by a sales associate, such as “We notice you are interested in our exciting new line of {Brand z}. A sales associate will be out to assist you shortly with any questions.”

Other combinations of the video messages 117 are also possible. In addition to displaying separate video welcoming messages 117-1 and video advertising messages 117-2 for each detected approach and reach-in interaction, respectively, the MCS 120 can also display a single video message 117 associated with a sequence of customer interactions.

For example, the MCS 120 can detect a customer approach but suspend the display of an associated video welcoming message 117-1 for a predetermined time period. If the MCS 120 detects a corresponding reach-in for products 110 before the time period expires, the MCS 120 can select and display only an associated video advertising messages 117-2 for related products.

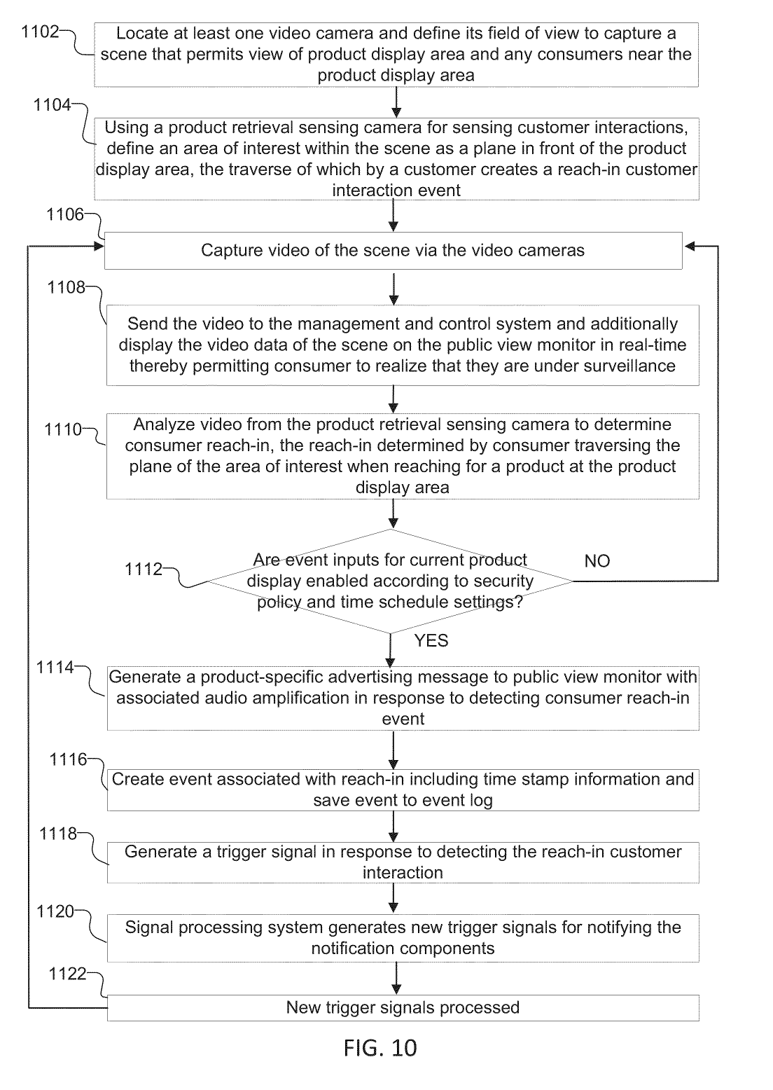

FIG. 10 is a flow chart that provides an exemplary method for detecting a typical example of a product retrieval attempt, a reach-in customer interaction, at a product display area 180 and for alerting loss prevention personnel in response to the detected reach-ins.

In step 1102, an operator locates at least one video camera 103 and defines its field of view 104 to capture a scene that permits view of the product display area 180 and any consumers 802 near the product display area 180. This includes consumers 802 standing in aisles 114 adjacent to the product display area 180. Then, in step 1104, using a product retrieval sensing camera 103-1 for sensing customer interactions, the operator defines an area of interest 152 within the scene as a plane in front of the product display area 180, the traverse of which by a customer 802 indicates a reach-in customer interaction.

In step 1106, the video camera 103 and retrieval sensing camera 103-1 capture video 116 of the scene. The video camera 103 sends the video 116 to the MCS 120. When the system is in PVM mode, the MCS 120 displays the video 116 of the scene on the public view monitor 106 in real-time. This allows the consumer 802 to realize that they are under surveillance, according to step 1108.

Then, in step 1110, the analytics system 186 of the MCS 120 analyzes the video 116-1 from the product retrieval sensing camera 103-1, to detect the consumer reach-in. The reach-in is detected by the consumer 802 traversing the plane of the area of interest 152 in the video 116-1 when reaching for a product 110 at the product display area 180. According to step 1112, the MCS 120 tests if event inputs for the current product display area 180 are enabled on the MCS 120 according to security policy and time schedule settings. If the test is true, the method continues to step 1114 to resume processing, otherwise, the method reverts to step 1106 to capture video 116 of the scene.

According to step 1114, the customer messaging system 134 of the MCS generates a product-specific advertising message 117 to the public view monitor 106 with associated audio amplification in response to detecting the consumer reach-in event.

In step 1116, the MCS 120 creates an event 156 associated with the reach-in including time stamp information and saves the event 156 to the event log 130.

Then, in step 1118, the analytics system 186 generates a trigger signal 136 in response to detecting the reach-in customer interaction. In step 1120, the signal processing system 128 generates new trigger signals 138 from the trigger signal 136 for notifying the notification components, and the notification components process the new trigger signals 138 in step 1122.

FIG. 11 is a flow chart that provides detail for step 1122 of the method of FIG. 10, for processing the new trigger signals 138. This provides detail for how remote user devices 132, such as mobile phones and tablet devices, and dedicated loss prevention workstations 154 in the Loss Prevention (LP) office are notified of the customer interactions.

In step 1134, the audio notification system 166 receives an audio trigger signal of the new trigger signals 138. The audio trigger signal, in examples, has a TTL value associated with a specific product 110 at the product display area 180. In response, the audio notification system 166 sends visual indications and audio chimes to the consumer 802 via a speaker 124 installed behind the product display area 180, according to step 1136.

In step 1138, the staff message notification system 150 receives a message trigger signal of the new trigger signals 138. The message trigger signal, in examples, has a TTL value associated with a specific product 110 at the product display area 180. In response, in step 1140, the staff message notification system 150 sends messages including system including pop-up messages 140, email messages 142, and SMS messages 144 to operators using Loss Prevention (LP) workstations 154 and to operators using user devices 132 over a network cloud 196. The user devices 132 include mobile phones and tablet devices, in examples.

In step 1142, the indicator system 176 receives an alarm trigger signal of the new trigger signals 138. The alarm trigger signal, in examples, has a TTL value associated with a specific product 110 at the product display area 180. In response, in step 1144, the indicator system 176 sends visual indications 146 and audio indications 148 such as chimes to the LP workstations 154 to alert operators.

FIG. 12 is a flow chart that provides an exemplary method for identifying potential thefts using events 156 created in response to detecting reach-in customer interactions. In the example, a loss prevention operator uses the LP workstations 154 and the MCS 120 to search for events 156 that may indicate suspicious activity at the product display area 180. In the example, the operator has reason to believe that the suspicious activity was associated with a specific high-value product 110 during peak hours.

In step 904, an operator selects a time/date range of event information 156 from the event log 130. In step 906, the operator accesses POS transaction data 302 for the selected time/date range of the selected events 156, and filters the result using the Stock Keeping Unit (SKU) number of the product 110.

According to step 908, the MCS 120 determines the number of product reach-in events 156 for the product 110 from the event log 130. The MCS 120 additionally addresses any time synchronization issues between the recorded events 156 and the current time. Then, in step 910, the operator compares the number of reach-ins to the SKU-filtered POS transaction data 302 for the same product 110. If the number of reach-ins for the product 110 exceeds the number of transactions in the POS transaction data 302 for the same product, each excess reach-in event 156 is identified as a potential theft for further analysis, in step 912.

In step 914, the MCS 120 validates potential thefts by comparing date/time stamp information for each excess reach-in event 156 with time/date stamp information of recorded video data 116 from the management and control system 120 for the same time period. Then, in step 916, the MCS 120 stores metadata for each validated theft as an event 156 to the event log 130 for review by other loss prevention personnel and law enforcement. Step 918 completes the processing of the method.

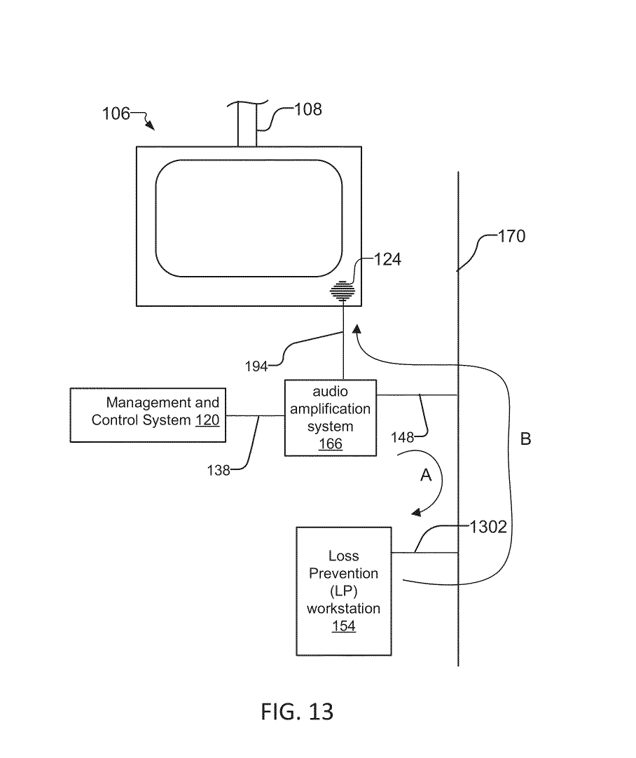

FIG. 13 is a block diagram showing major components of the theft deterrent system 100 that are associated with an audio override message 1302 or “voice down” feature. A PVM 106 includes an integrated speaker 124 that receives audio messages 194 from an audio notification system 166. The audio notification system 166 includes an interface that enables audio communications over the security network 170.

In an example, the MCS 120 sends new trigger signals 138 in response to detecting suspicious customer interactions at a product display area 180. An audio message signal of the new trigger signals 138 is received by the audio notification system 166. The audio message signal is indicative of the nature of the activity and is associated with specific products 110 at a product display area 180. In response, the audio notification system 166 notifies operators on LP workstations via an audio indication 148, such as an audible chime. The path that the audio indication 148 traverses is indicated by arc reference “A.”

In response to receiving the audible chime, an operator sends an audio override message 1302 over the security network 170 to the audio notification system 166. The audio notification system 166, in turn, sends the audio override message 1302 for playback at the speaker 124 of the PVM 106. Typically, the audio override message 1302 is a “voice down” message spoken directly by an operator using a microphone, where the operator warns the would-be thief or asks if the consumer needs further assistance, in examples. The path that the audio override message 1302 traverses is indicated by arc reference “B.”

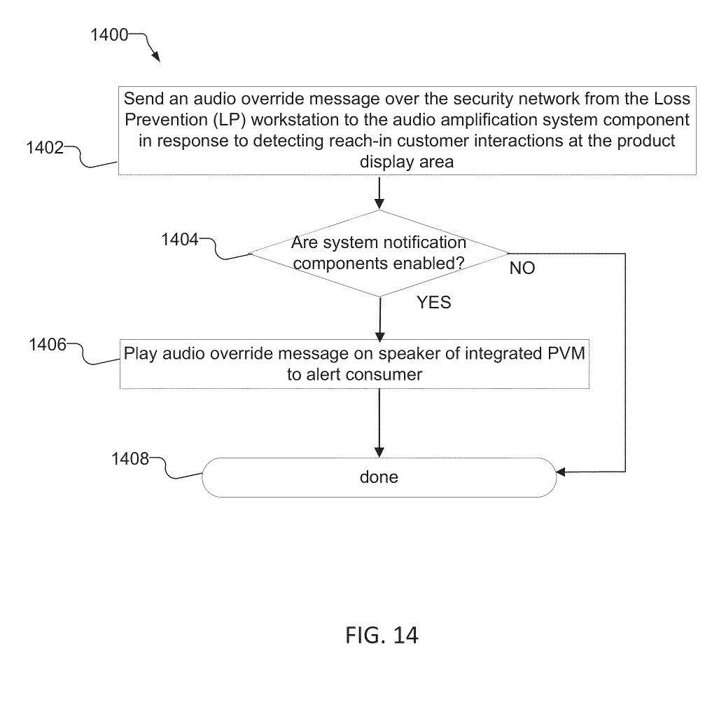

FIG. 14 is a flow chart showing a method 1400 for sending audio override messages 1302 also known as “voice down” messages associated with components of the block diagram in FIG. 13. This illustrates the “on demand” nature of the audio override message 1302 capability and to distinguish it from the more deterministic trigger/notification audio message 194 capability of the method in FIG. 10.

In step 1402, the operator sends an audio override message 1302 over the security network 107 from a Loss Prevention (LP) workstation 154 to the audio notification system 166 in response to the MCS 120 detecting reach-in customer interactions at the product display area 180. In step 1404, the LP workstation 154 tests that system notification components, such as the audio notification system component 166, are enabled. If the test is true, in step 1406, the audio notification system 166 plays the audio override message 1302 on the integrated speaker 124 of the PVM. Else, step 1408 completes the processing of the method. In other examples, the audio override message 1302 is played on a speaker 124 located behind the product display area 180.

FIG. 15 is a state machine diagram that identifies major states of the theft deterrent system 100 that occur during its operation. The major states are represented by blocks that include a unique state name and associated state number. The system 100 states include OFFLINE (0), PVM Mode (1), PRESENCE (2), PRODUCT ATTEMPT (3), MESSAGE I (4), MESSAGE II (5), and VOICE DOWN (6) states.

The OFFLINE (0) state is associated with inactivity. This includes times when the system is unstaffed, such as when the retail location is closed for business or the system 100 is administratively disabled for a specific product display area 180. When the system 100 is staffed or enabled, such as according to an automated schedule associated with normal operating hours of the retail location, the system 100 transitions to the PVM Mode (1) state.

The PVM Mode (1) state is associated with the display of video 116. The video displayed on the PVM 106 includes video 116 transmitted directly from the video camera 103 and video 116 transmitted through the video recorder system 118 The PVM Mode (1) state runs concurrently with all other states except the OFFLINE (0) state. In response to the audio notification system 166 receiving a “voice down” message 1302 from an operator using a microphone on a loss prevention workstation 154, the PVM Mode (1) state transitions to the VOICE DOWN (6) state. In response to the MCS 120 detecting customer reach-in interactions, and customer approach interactions that indicate customer presence at a product display area 180, the system 100 transitions to the PRODUCT ATTEMPT (3) and PRESENCE (2) states, respectively.

When in the PRESENCE (2) state, the system 100 is actively detecting and/or processing a detected approach customer interaction. Upon completing the detection processing, the system 100 creates an associated event 156 and saves it to the event log 130. In addition, the system 100 selects and send audio messages 194 and/or video messages 117 to the consumer 802 at the product display area 180 in response to detecting the customer interactions. In a similar fashion, when the system 100 is in the PRODUCT ATTEMPT (3) state, the system 100 is actively detecting and/or processing a detected reach-in customer interaction. Upon completing the detection processing, the system 100 creates an associated event 156 and saves it to the event log 130. In addition, the system 100 selects and send audio messages 194 and video messages 117 to the consumer 802 at the product display area 180 and to loss prevention personnel in response to detecting the customer interactions.

The two message states MESSAGE I (4) and MESSAGE II (5) are reached after the system 100 has selected audio messages 194 and video messages 117 in response to detecting customer interactions. In addition, the MESSAGE I (4) and MESSAGE II (5) states are reached in response to receiving an audio override message 1302. The audio override message 1302 is typically issued from an operator using a microphone on a loss-prevention workstation 154. The message states (4) and (5) are each associated with both audio messages 194 and video messages 117 and are presented as separate states to alleviate potential clutter in the drawing.

The VOICE DOWN (6) state is associated with the audio override message 1302 feature. This is typically a transient event. In response to an operator sending an audio override message 1302, the system 100 can transition to the MESSAGE (4) and (5) states to generate messages in response to the audio override message 1302.

While this invention has been particularly shown and described with references to preferred embodiments thereof, it will be understood by those skilled in the art that various changes in form and details may be made therein without departing from the scope of the invention encompassed by the appended claims.

What is claimed is:

1. A theft deterrence and analysis system, comprising:
a video camera that generates video of a product display area;
a public view monitor (PVM) positioned relative to the product display area; and
a management and control system that controls, in response to detecting customer interactions with the product display area, messaging at the product display area including audio messages and/or video displayed on the PVM, the video displayed on the PVM including video from the video camera.

2. The system of claim 1, wherein the customer interaction with the product display area includes:
approach of the product display area;
product retrieval attempts for products in the product display area; and/or
motion associated with the products at the product display area.

3. The system of claim 1, further comprising a product retrieval sensing camera that generates video of the product display area and detects the customer interactions with the product display area, and wherein the management and control system changes the video displayed on the PVM in response to detecting the customer interactions.

4. The system of claim 3, wherein the video includes audio and/or video welcoming messages and audio and/or video advertising messages.

5. The system of claim 3, wherein the management and control system includes a customer messaging system and a logical control system, and wherein the logical control system changes the video displayed on the PVM in response to detecting the customer interactions by selecting messages from the customer messaging system, mixing the messages and the video from the video camera into mixed video data, and providing the mixed video data for display on the PVM.

6. The system of claim 5, wherein the messages include audio and/or video welcoming messages and audio and/or video advertising messages.

7. The system of claim 3, wherein the management and control system detects product retrieval attempt customer interactions by enabling definition of an area of interest within video from the product retrieval sensing camera defined by a vertical plane in front of the product display area or a boundary around the product display area, and identifying traversal of the area of the interest by the customers in the video.

8. The system of claim 1, wherein the management and control system notifies an audio amplification system to present an audio message to the customers in response to detecting the customer interactions.

9. The system of claim 1, further comprising sensor devices that define a motion trigger zone near the product display area, and wherein the management and control system detects product retrieval attempt customer interactions from sensor data sent by the sensor devices that indicates traversal of the motion trigger zone by the customers.

10. The system of claim 1, wherein the management and control system notifies loss prevention personnel in response to detecting the customer interactions.

11. The system of claim 10, wherein the management and control system notifies the loss prevention personnel by generating trigger signals to notification components in response to detecting the customer interactions, and wherein the notification components send indications and messages associated with the detected customer interactions to the loss prevention personnel in response to receiving the trigger signals.

12. The system of claim 11, wherein the notification components send the indications and the messages associated with the detected customer interactions to user devices via a network cloud.

13. The system of claim 10, wherein in response to the management and control system notifying the loss prevention personnel, the loss prevention personnel send audio voice down messages to the customers near the product display area.

14. A theft deterrence and analysis system, comprising:
a video camera that generates video of a product display area;
a public view monitor (PVM) positioned relative to the product display area; and
a management and control system that controls video displayed on the PVM in response to detecting customer interactions with the product display area, and forwards images of customers in the video to loss prevention personnel in response to detecting the customer interactions.

15. A targeted advertising system, comprising:
a video camera that generates video of a product display area;
a public view monitor (PVM) positioned relative to the product display area;
a management and control system that includes audio and/or video messages associated with products at the product display area and controls video displayed on the PVM in response to detecting customer interactions with the product display area, the video displayed on the PVM including the audio and/or video messages; and
an enterprise message content server that periodically updates the audio and/or video messages on the management and control system over a network cloud.

16. A theft deterrence and analysis system, comprising:
a video camera that generates video of a product display area that includes products;
a public view monitor (PVM) positioned relative to the product display area;
point of sale (POS) terminals that generate POS transaction data for transactions associated with the products at the POS terminals;
a system data archive that stores the POS transaction data; and
a management and control system that:
controls video displayed on the PVM in response to detecting customer interactions with the product display area;
records the video from the video camera;
creates and saves events in response to detecting the customer interactions; and
compares the events in conjunction with the POS transaction data and the recorded video to identify and/or validate theft of the products.

17. A method for deterring theft at a product display area, the method comprising:
generating video of the product display area via a video camera;
positioning a public view monitor (PVM) relative to the product display area; and
controlling messaging at the product display area including audio messages and/or video displayed on the PVM in response to detecting customer interactions with the product display area, the video displayed on the PVM including video from the video camera.

18. The method of claim 17, wherein detecting the customer interaction with the product display area includes:
detecting approach of the product display area;
detecting product retrieval attempts for products in the product display area; and/or
detecting motion associated with the products at the product display area.

19. The method of claim 17, further comprising changing the video displayed on the PVM in response to detecting the customer interactions.

20. The method of claim 17, further comprising notifying an audio amplification system to present an audio message to the customers in response to detecting the customer interactions.

21. The method of claim 17, further comprising detecting product retrieval attempt customer interactions with the product display area, and changing the video displayed on the PVM in response to detecting the product retrieval attempt customer interactions.

22. The method of claim 17, further comprising detecting product retrieval attempt customer interactions by enabling definition of an area of interest within the video defined by a vertical plane in front of the product display area or a boundary around the product display area, and identifying traversal of the area of the interest by the customers in the video.

23. The method of claim 17, further comprising detecting product retrieval attempt customer interactions by defining a motion trigger zone near the product display area using sensor devices, and identifying traversal of the motion trigger zone by the customers from sensor data sent by the sensor devices.

24. The method of claim 17, further comprising notifying loss prevention personnel in response to detecting the customer interactions.

25. The method of claim 17, further comprising forwarding images of customers in the video to loss prevention personnel in response to detecting the customer interactions.

26. The method of claim 17, further comprising sending video advertising messages associated with products in the product display area in response to detecting the customer interactions, the video displayed on the PVM including the video advertising messages.

27. The method of claim 17, further comprising:
generating point of sale (POS) transaction data for transactions associated with products at the product display area, and storing the POS transaction data;
recording the video from the video camera;
creating and storing events in response to detecting the customer interactions; and
comparing the events in conjunction with the POS transaction data and the recorded video to identify and/or validate theft of the products.

28. The method of claim 17, further comprising:
generating marketing data related to customer interaction with the product display area and storing the marketing data;
recording the video from the video camera;
creating and storing events in response to detecting the customer interactions, wherein the events define consumer reaction to the product display area; and
developing consumer behavior marketing metadata and statistics in relation to the product display area using the stored events.
